(19) United States
(12) Patent Application Publication
(10) Pub. No.: US 2006/0066572 A1
(43) Pub. Date: Mar. 30, 2006

(54) Pointing device offering good operability at low cost

(75) Inventors: Manabu Yumoto, Nara-shi (JP); Takahiko Nakano, Ikoma-shi (JP); Takuji Urata, Nara-shi (JP); Sohichi Miyata, Nara-shi (JP); Jun Ueda, Ikoma-shi (JP); Tsukasa Ogasawara, Ikoma-shi (JP)

Correspondence Address: BIRCH STEWART KOLASCH & BIRCH, PO BOX 747, FALLS CHURCH, VA, 22040-0747, US

(73) Assignees: Sharp Kabushiki Kaisha; National University Corporation Nara Institute of Science and Technology

(21) Appl. No.: 11/235,378

(22) Filed: Sep. 27, 2005

(30) Foreign Application Priority Data
Sep. 28, 2004 (JP) 2004-281989(P)

(51) Int. Cl. G09G 5/08

(52) U.S. Cl. 345/157

(57) ABSTRACT

A pointing device includes a sensor obtaining image information, and an image producing unit producing a comparison image at predetermined time intervals by lowering a spatial resolution of an image based on the image information obtained by the sensor and increasing a density resolution of the image based on the image information. The device arithmetically obtains a correlation value indicating a correlation between a predetermined region in a first comparison image among the plurality of comparison images produced by the image producing unit and a predetermined region in a second comparison image produced after the first comparison image.

This nonprovisional application is based on Japanese Patent Application No. 2004-281989 filed with the Japan Patent Office on Sep. 28, 2004, the entire contents of which are hereby incorporated by reference.

### BACKGROUND OF THE INVENTION

1. Field of the Invention

The present invention relates to a pointing device for providing an instruction to a computer from a finger, and moving a pointer (cursor) on a display screen in a direction according to a movement of the finger, and particularly to a small pointing device allowing continuous input and user collation.

2. Description of the Background Art

For small portable information terminals, and particularly for mobile phones, such pointing devices have been developed that can move a pointer (cursor) on a display screen in a direction according to a movement of a finger based on a fingerprint.

Japanese Patent Laying-Open No. 2002-062983 has disclosed a technique relating to a technique of the above kind of pointing device, which uses a finger plate of a special form or shape in a portion for contact with a fingertip for allowing easy detection of a position of the fingertip and ensuring small sizes.

Recently, a device having the above structure of the pointing device and additionally having a function of user collation has also been developed.

FIG. 11 is a block diagram illustrating a structure of a conventional pointing device 10.

Referring to FIG. 11, pointing device 10 includes a fingerprint image reading unit 101, a controller 119 and a storing unit 130.

Fingerprint image reading unit 101 reads a fingerprint of a user as an image at predetermined intervals, e.g., of 33 milliseconds. In the following description, the image read by fingerprint image reading unit 101 may also be referred to as a “read fingerprint image.”

Storing unit 130 stores the read fingerprint image read by fingerprint image reading unit 101. Storing unit 130 has prestored fingerprint images for user collation. These may also be referred to as “collation fingerprint images” hereinafter. The collation fingerprint images are images of fingerprints that are registered in advance by the users.

Controller 119 includes a fingerprint collating unit 107, a correlation value arithmetic unit 104 and a data converter 105.

Fingerprint collating unit 107 performs user collation based on the read fingerprint image read by fingerprint image reading unit 01 and the collation fingerprint image.

Correlation value arithmetic unit 104 compares the read fingerprint image, which is stored in storing unit 130 (and may also be referred to as a “pre-movement read fingerprint image” hereinafter), with the read fingerprint image which is read by fingerprint image reading unit 101 after storing unit 130 stores the read fingerprint image (e.g., after several frames), and may also be referred to as a “moved read fingerprint image” hereinafter). From this comparison, correlation value arithmetic unit 104 calculates an image correlation value (e.g., movement vector value) based on a motion of the user's finger.

Pointing device 10 further includes a display controller 106 and a display unit 110.

Based on the movement vector value calculated by correlation value arithmetic unit 104, data converter 105 performs the conversion to provide an output value for causing display controller 106 to perform a predetermined operation.

Based on the output value provided from data converter 105, display controller 106 performs the control to move and display a pointer (cursor) or the like on display unit 110.

According to the technique disclosed in Japanese Patent Laying-Open No. 2002-062983, it is necessary to cover the fingerprint sensor with the finger plate of a special form, and the sizes can be reduced only to a limited extent.

Also, the technique disclosed in Japanese Patent Laying-Open No. 2002-062983 requires a special sensor device, and thus can reduce a cost only to a limited extent.

Further, according to the technique disclosed in Japanese Patent Laying-Open No. 2002-062983, the longitudinal and lateral directions are limited according to a guide shape of the finger plate so that the cursor cannot be moved easily in directions other than those of the guide.

Further, the technique disclosed in Japanese Patent Laying-Open No. 2002-062983 employs a conventional image processing technique, and more specifically employs a method of calculating the image correlation value directly from the obtained fingerprint image and the fingerprint image preceding it by one or several frames, and thereby calculating the movement of the image.

In the above method, since movements are detected by using the image obtained by the fingerprint sensor as it is, a long arithmetic operation time is required for calculating the image correlation value so that it may be impossible to move the pointer (cursor) on the display screen according to the motion of the finger in real time.

### SUMMARY OF THE INVENTION

An object of the invention is to provide a pointing device offering good operability at a low cost.

According to an aspect of the invention, a pointing device includes a sensor obtaining image information; an image producing unit producing a comparison image at predetermined time intervals by lowering a spatial resolution of an image based on the image information obtained by the sensor and increasing a density resolution of the image based on the image information; a storing unit storing a first comparison image among the plurality of comparison images produced by the image producing unit; a correlation value arithmetic unit arithmetically obtaining a correlation value indicating a correlation between a predetermined region in a second comparison image produced by the image producing unit after the first comparison image among the plurality of comparison images and a predetermined region in the first comparison image; and a data converter detecting an operation of a user from the correlation value, and converting the detected operation to an output value for supply to a computer.

Preferably, the pointing device further includes a display unit displaying an image, and a display controller moving a pointer on the display unit according to the output value.

Preferably, the sensor obtains the image information in the form of a binary image, and the image producing unit divides the binary image into a plurality of regions, calculates a conversion pixel value based on a plurality of pixel values provided by each of the plurality of regions, and produces the comparison image having the plurality of calculated conversion pixel values as the pixel values of the corresponding regions, respectively.

Preferably, the sensor obtains a fingerprint or fingerprint image information derived from the fingerprint as the image information.

Preferably, the pointing device further includes a fingerprint collating unit for collating the fingerprint image information with prestored fingerprint data.

Preferably, an image information reading scheme of the sensor is a capacitance type, an optical type or a pressure-sensitive type.

Accordingly, the invention can significantly reduce an arithmetic quantity required for arithmetically obtaining the correlation value. Therefore, even when an inexpensive arithmetic processor is used, the pointing device can sufficiently achieve its intended function. Consequently, the invention can provide the inexpensive pointing device.

Further, in the pointing device according to the invention, the sensor obtains the image information in the form of the binary image, and the image producing unit divides the binary image into the plurality of regions, calculates the conversion pixel value based on the plurality of pixel values provided by each of the plurality of regions, and produces the comparison image having the plurality of calculated conversion pixel values as the pixel values of the corresponding regions, respectively. Accordingly, an inexpensive sensor, which obtains the image information in the form of the binary image, can be used so that the invention can provide the inexpensive pointing device.

The pointing device according to the invention further includes the fingerprint collating unit collating the fingerprint image information with the prestored fingerprint data. Therefore, the single device can achieve both the personal collation function using the fingerprint and the function of the pointing device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an outer appearance of a pointing device according to a first embodiment.

FIG. 2 shows a specific structure of a fingerprint sensor.

FIG. 3 is a top view of the pointing device according to the invention.

FIG. 4 is a block diagram illustrating a structure of the pointing device.

FIGS. 5A, 5B, 5C and 5D show images before or after processing by a comparison image producing unit.

FIGS. 6A and 6B illustrate images before or after the processing by the comparison image producing unit.

FIG. 7 is a flowchart illustrating a correlation value arithmetic processing.

FIGS. 8A and 8B illustrate regions set in a comparison image.

FIGS. 9A and 9B illustrate processing of calculating a movement vector value.

FIG. 10 is a block diagram illustrating a structure of a pointing device connected to a PC.

FIG. 11 is a block diagram illustrating a structure of a conventional pointing device.

### DESCRIPTION OF THE PREFERRED EMBODIMENTS

Embodiments of the invention will now be described with reference to the drawings. In the following description, the corresponding portions bear the same reference numbers and the same names, and achieve the same functions. Therefore, description thereof is not repeated.

### First Embodiment

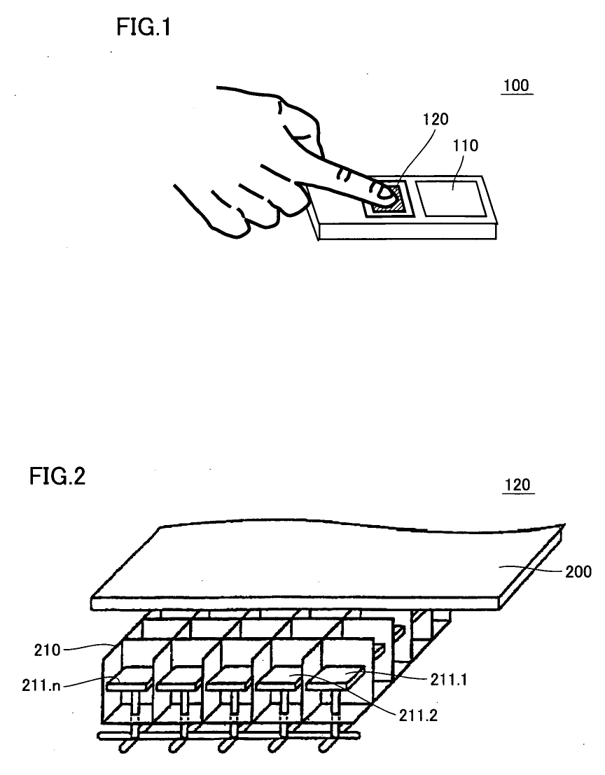

Referring to FIG. 1, a pointing device 100 includes a display unit 110 and a fingerprint sensor 120.

Display unit 110 may be of any image display type, and may be an LCD (Liquid Crystal Display), CRT (Cathode Ray Tube), FED (Field Emission Display), PDP (Plasma Display Panel), Organic EL display (Organic ElectroLuminescence Display), dot matrix display or the like.

Fingerprint sensor 120 has a function of detecting a fingerprint of a user's fingerprint.

FIG. 2 shows a specific structure of fingerprint sensor 120. A sensor of the capacitance type is shown as an example of the sensor in the invention. In the invention, however, the fingerprint sensor is not restricted to the capacitance type, and may be of the optical type, the pressure-sensitive type or the like.

Referring to FIG. 2, fingerprint sensor 120 includes an electrode group 210 and a protective film 200 arranged over electrode group 210.

Electrode group 210 has electrodes 211.1, 211.2, . . . 211.n arranged in a matrix form. Electrodes 211.1, 211.2, . . . 211.n may be collectively referred to as “electrodes 211” hereinafter.

Electrode 211 has characteristics that a charge quantity thereof varies depending on concavity and convexity of, for example, a finger placed on protective film 200 (that is, depending on a distance between protective film 200 and a surface of the finger). A charge quantity of electrode 211 on which a trough (concave) portion of a fingerprint is placed is smaller than that of electrode 211 on which a ridge (convex) portion of the fingerprint is placed.

A quantity of charges carried on electrode 211 is converted, e.g., into a voltage value, which is then converted into a digital value so that an image of the fingerprint is obtained.

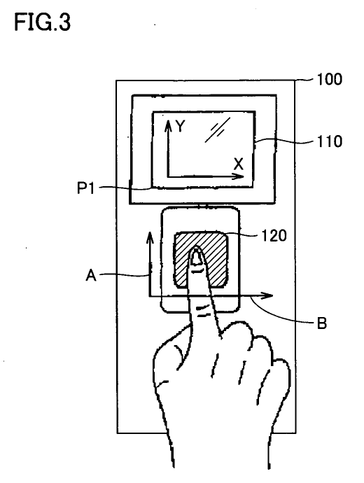

Referring to FIG. 3, the user moves the finger on fingerprint sensor 120 to move and display a pointer on display unit 110. In the following description, a direction indicated by an arrow A may be referred to as an “up direction” with respect to fingerprint sensor 120, and the opposite direction may be referred to as a “down direction”. Also, a direction indicated by an arrow B and the opposite direction may also be referred to as a “right direction” and a “left direction”, respectively.

On display unit 110, a lower left position P1 is defined as an origin, coordinates in an X direction are defined as X coordinates, and coordinates in a Y direction are defined as Y coordinates.

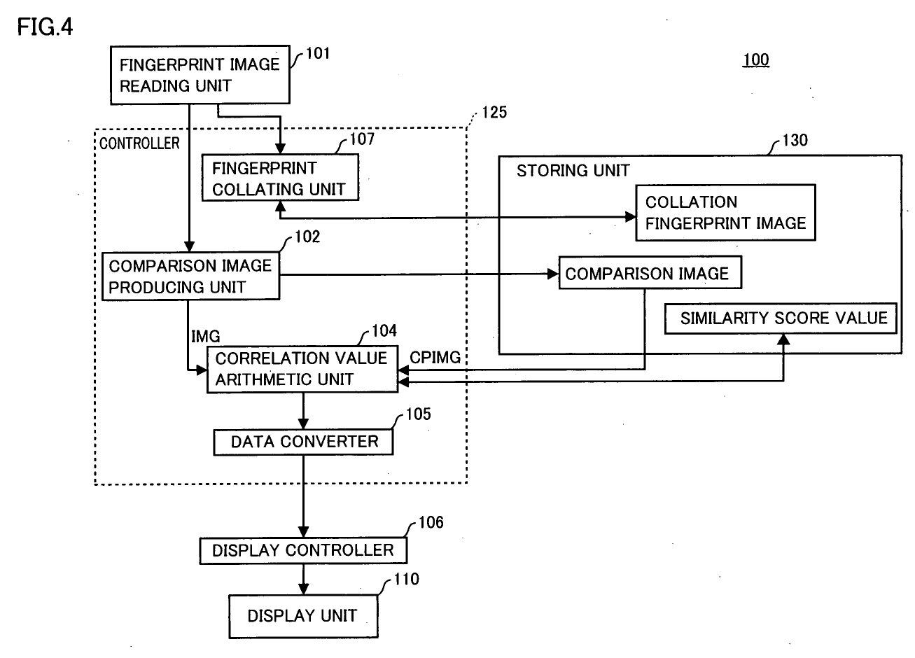

Referring to FIG. 4, pointing device 100 includes a fingerprint image reading unit 101, a controller 125 and a storing unit 130.

Fingerprint image reading unit 101 is foregoing fingerprint sensor 120. Fingerprint image reading unit 101 reads an image of the user's fingerprint in the form of a binary monochrome image (which may also be referred to as a “read fingerprint binary image” hereinafter) at predetermined intervals, e.g., of 33 milliseconds.

Storing unit 130 has stored in advance the foregoing collation fingerprint image prepared from the user's fingerprint. Storing unit 130 is medium (e.g., flash memory) that can hold data even when it is not supplied with a power.

More specifically, storing unit 130 may be any one of an EPROM (Erasable Programmable Read Only Memory) that can erase and write data infinite times, an EEPROM (Electronically Erasable and Programmable Read Only Memory) allowing electrical rewriting of contents, an UV-EPROM (Ultra-Violet Erasable Programmable Read Only Memory) that can erase and rewrite of storage contents infinite times with ultraviolet light and others circuits which can nonvolatilely store and hold data.

Storing unit 130 may be any one of a RAM (Random Access Memory), an SRAM (Static Random Access Memory), a DRAM (Dynamic Random Access Memory) and an SDRAM (Synchronous DRAM) which can temporarily store data, as well as a DDR-SDRAM (Double Data Rate SDRAM), which is an SDRAM having a fast data transfer function called “double data rate mode”, a RDRAM (Rambus Dynamic Random Access Memory) which is a DRAM employing a fast interface technique developed by Rambus Corp., a Direct-RDRAM (Direct Rambus Dynamic Random Access Memory) and other circuits which can nonvolatilely store and hold data.

Controller 125 includes a fingerprint collating unit 107 and a comparison image producing unit 102.

Fingerprint collating unit 107 determines whether the read fingerprint binary image read by fingerprint image reading unit 101 matches with the collation fingerprint image or not. When fingerprint collating unit 107 determines that the read fingerprint binary image matches with the collation fingerprint image, the user can use pointing device 100. When fingerprint collating unit 107 determines that the read fingerprint binary image does not match with the collation fingerprint image, the user cannot use pointing device 100.

Comparison image producing unit 102 successively processes the read fingerprint binary image successively read by fingerprint image reading unit 101 to produce images by lowering spatial resolutions and increasing density resolutions. The images thus produced may also be referred to as “comparison images” hereinafter. The lowering of the spatial resolution is equivalent to lowering of the longitudinal and lateral resolutions of the image. The increasing of the density resolution is equivalent to changing of the image density represented at two levels into the image density represented, e.g., at five levels.

Comparison image producing unit 102 successively stores the produced comparison images in storing unit 130 by overwriting.

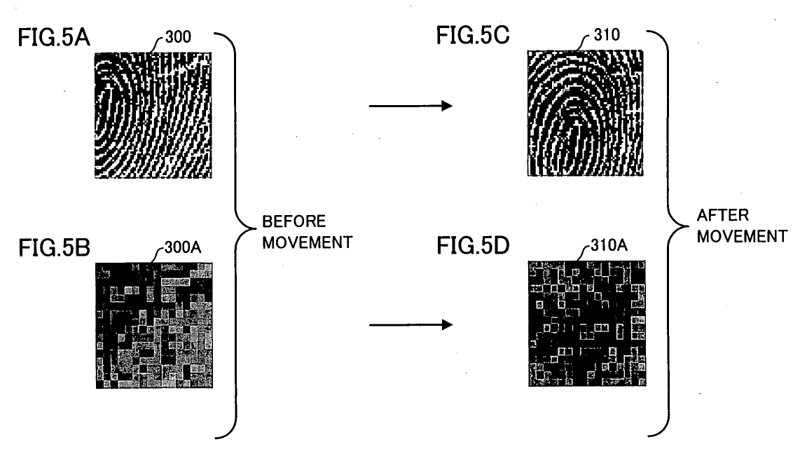

FIG. 5A shows a read fingerprint binary image 300 read by fingerprint image reading unit 101.

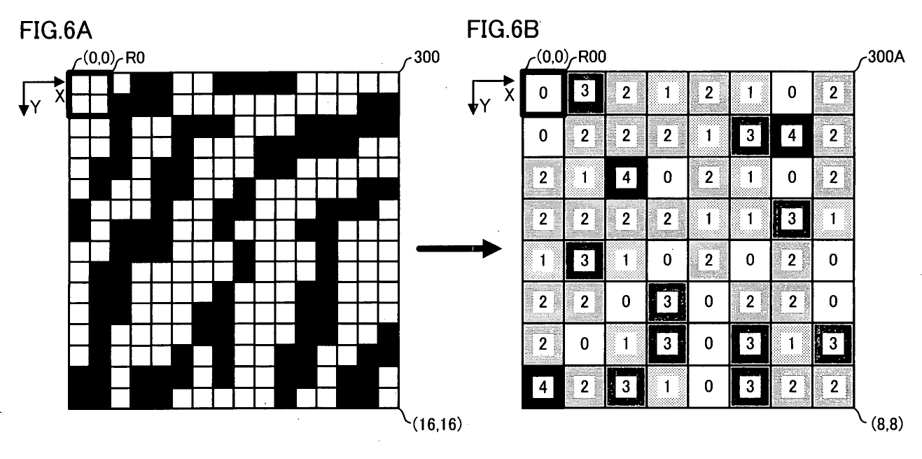

FIG. 6A illustrates read fingerprint binary image 300. Read fingerprint binary image 300 shown in FIG. 5A is illustrated in FIG. 6A by representing each of pixels in white or black. A white pixel indicates a pixel value of “0”, and a black pixel indicates a pixel value of “1”.

Read fingerprint binary image 300 is formed of, e.g., 256 pixels arranged in a 16-by 16-pixel matrix. An upper left end is indicated by coordinates (0, 0), and a lower right end is indicated by coordinates (16, 16). Read fingerprint binary image 300 is not restricted to the 16 by 16 matrix of dots, and may have arbitrary sizes. For example, read fingerprint binary image 300 may be formed of a 256 by 256 matrix of dots.

FIG. 6B illustrates a comparison image 300A, which is produced from read fingerprint binary image 300 by comparison image producing unit 102 lowering the spatial resolution and increasing the density resolution.

Comparison image 300A is produced in such a manner that read fingerprint binary image 300 is divided into regions (i.e., divided regions) such as a region R0 each formed of a 2 by 2 matrix of 4 pixels, each divided region (e.g., region R0) is replaced with one pixel (pixel R00) in comparison image 300A and the density resolution of each pixel is increased. More specifically, each of the divided regions in read fingerprint binary image 300 is processed by calculating a sum of the pixel values (which may also be referred to as “in-region pixel values” hereinafter), and comparison image 300A is produced based on the pixel values thus calculated.

When all the four pixels of the divided region (e.g., region R0) in read fingerprint binary image 300 are white, the in-region pixel value is “0”. When one pixel among the four pixels of the divided region in read fingerprint binary image 300 is black, the in-region pixel value is “1”.

When two pixels among the four pixels of the divided region in read fingerprint binary image 300 are black, the in-region pixel value is “2”. When three pixels among the four pixels of the divided region in read fingerprint binary image 300 are black, the in-region pixel value is “3”. When four pixels among the four pixels of the divided region in read fingerprint binary image 300 are black, the in-region pixel value is “4”.

Based on the above calculation, comparison image producing unit 102 produces comparison image 300A in FIG. 6B from read fingerprint binary image 300 in FIG. 6A. Comparison image 300A is formed of an 8 by 8 matrix of 64 pixels. In the following description, comparison image producing unit 102 produces comparison image 300A at a time t1.

Each divided region is not restricted to a 2-by 2-pixel matrix, and may be arbitrarily set to other sizes such as a 2-by 2-pixel matrix.

Referring to FIGS. 5A-5D, FIG. 5B shows an image corresponding to comparison image 300A in FIG. 6B.

FIG. 5C shows a read fingerprint binary image 310 which is read by fingerprint image reading unit 101 after storing unit 130 stores comparison image 300A (e.g., after several frames).

FIG. 5D shows a comparison image 310A produced by comparison image producing unit 102 based on read fingerprint binary image 310.

Referring to FIG. 4 again, controller 125 further includes a correlation value arithmetic unit 104.

Correlation value arithmetic unit 104 makes a comparison between comparison image 300A stored in storing unit 130 and comparison image 310A produced by comparison image producing unit 102 after comparison image 300A. According to this comparison, correlation value arithmetic unit 104 arithmetically obtains the image correlation values such as a movement vector value and a movement quantity based on a motion of the user's finger. In the following description, the arithmetic processing of obtaining the image-correlation value by correlation value arithmetic unit 104 may also be referred to as correlation value arithmetic processing. Further, it is assumed that comparison image producing unit 102 produces comparison image 310A at a time t2.

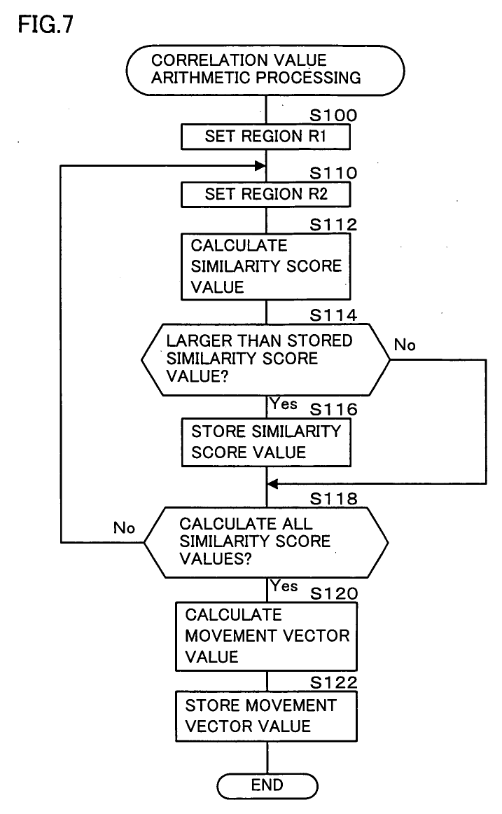

Referring to FIG. 7, correlation value arithmetic unit 104 reads comparison image 300A (CPIMG) from storing unit 130 in step S100. Correlation value arithmetic unit 104 sets a region R1 in comparison image 300A (CPIMG).

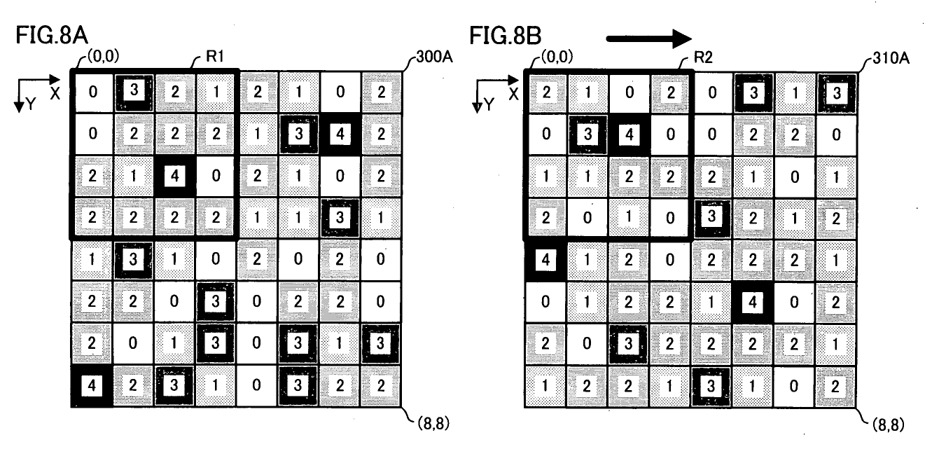

FIG. 8A illustrates region R1 set in comparison image 300A (CPIMG). In FIG. 8A, region R1 is set at an upper left position in comparison image 300A (CPIMG). However, region R1 may be set at any position in comparison image 300A (CPIMG), and may be set in the middle of comparison image 300A (CPIMG).

Referring to FIG. 7 again, processing is performed in step S110 after the processing in step S100.

In step S110, a region R2 is set in comparison image 310A (IMG) produced by comparison image producing unit 102.

Referring to FIGS. 8A and 8B again, FIG. 8B illustrates region R2 set in comparison image 310A (IMG). Region R2 has the same size as region R1. Each of regions R1 and R2 has a longitudinal size of h and a lateral size of w. Region R2 is first set at an upper left position in comparison image 31 OA (IMG). In this embodiment, although regions R1 and R2 are rectangular, these regions may have another shape according to the invention. For example, regions R1 and R2 may be circular, oval or rhombic.

Referring to FIG. 7 again, processing in step S112 is performed after the processing in step S110.

In step S112, correlation value arithmetic unit 104 performs pattern matching on region R1 in comparison image 300A (CPIMG) and region R2 in comparison image 310A (IMG). The pattern matching is performed based on the following equation (1).

$$C1 ( s , t ) = {\sum }_{y = 0}^{h - 1} {\sum }_{x = 0}^{w - 1} ( V0 - \vert R1 ( x , y ) - R2 ( s + x , t + y ) \vert ) \qquad ( 1 )$$

C1 (s, t) indicates a similarity score value according to the equation (1), and increases with the similarity score value. (s, t) indicates coordinates of region R2. The initial coordinates of region R2 are (0, 0). V0 indicates the maximum pixel value in comparison images 300A (CPIMG) and 310A (IMG), and is equal to “4” in this embodiment. R1(x, y) is a pixel value at coordinates (x, y) of region R1. R2(s+x, t+y) is a pixel value at coordinates (s+x, t+y) of region R2. Further, h is equal to 4, and w is equal to 4.

First, a similarity score value C1(0, 0) is calculated according to equation (1). In this stage, the coordinates of R2 are (0, 0). From equation (1), the score value of similarity between the pixel values of regions R1 and R2 is calculated. Then, processing is performed in step S114. This embodiment does not use read fingerprint binary image 300, and alternatively uses the comparison image having pixels reduced in number to a quarter so that the calculation processing for the similarity score values is reduced to a quarter.

The equation used for the pattern matching is not limited to the equation (1), and another equation such as the following equation (2) may be used.

$$C1 ( s , t ) = {\sum }_{y = 0}^{h - 1} {\sum }_{x = 0}^{w - 1} {( R1 ( x , y ) - R2 ( s + x , t + y ) )}^{2} \qquad ( 2 )$$

In step S114, it is determined whether the similarity score value calculated in step S112 is larger than the similarity score value stored in storing unit 130 or not. Storing unit 130 has stored “0” as the initial value of the similarity score value. Therefore, when the processing in step S114 is first performed, it is determined in step S114 that the similarity score value calculated in step S112 is larger than that stored in storing unit 130, and processing in step S116 is performed.

In step S116, correlation value arithmetic unit 104 stores the similarity score value calculated in step S112 and the coordinate values of region R2 corresponding to the calculated similarity score value in storing unit 130 by overwriting them. Then, processing is performed in step S118.

In step S118, it is determined whether all the similarity score values are calculated or not. When the processing in step S118 is first performed, only one similarity score value has been calculated so that processing will be performed in step S110 again.

In step S110, region R2 is set in comparison image 310A. Region R2 is moved rightward (in the X direction) by one pixel from the upper left of comparison image 310A in response to every processing in step S110.

After region R2 moved to the right end in comparison image 310A, region R2 is then set in a left end position of coordinates (0, 1) shifted downward (in the Y direction) by one pixel. Thereafter, region R2 moves rightward (in the X direction) by one pixel in response to every processing in step S110. The above movement and processing are repeated, and region R2 is finally set at the lower right end in comparison image 310A. After step S110, the processing in foregoing step S112 is performed.

In step S12, processing similar to the processing already described is performed, and therefore description thereof is not repeated. Then, processing is performed in step S114.

In step S114, it is determined whether the similarity score value calculated in step S112 is larger than the similarity score value stored in storing unit 130 or not. When it is determined in step S114 that the similarity score value calculated in step S112 is larger than the similarity score value stored in storing unit 130, the processing in step S116 already described is performed. When it is determined in step S114 that the similarity score value calculated in step S112 is not larger than the similarity score value stored in storing unit 130, the processing is performed in step S118.

The processing in foregoing steps S110, S112, S114 and S116 are repeated until the conditions in step S118 are satisfied so that storing unit 130 stores the maximum value (which may also be referred to as a “maximum similarity score value” hereinafter) of the similarity score value and the coordinate values of region R2 corresponding to the maximum similarity score value. In this embodiment, since the comparison image having the pixels reduced in number to a quarter is used instead of read fingerprint binary image 300, the number of times that the processing in steps S110, S112, S114 and S116 are repeated is a quarter of that in the case of using read fingerprint binary image 300.

When the conditions in step S118 are satisfied, the processing is then performed in step S120.

In step S120, the movement vector value is calculated based on the coordinate values (which may also be referred to as “maximum similarity coordinate values” hereinafter) of region R2 corresponding to the maximum similarity score value stored in storing unit 130.

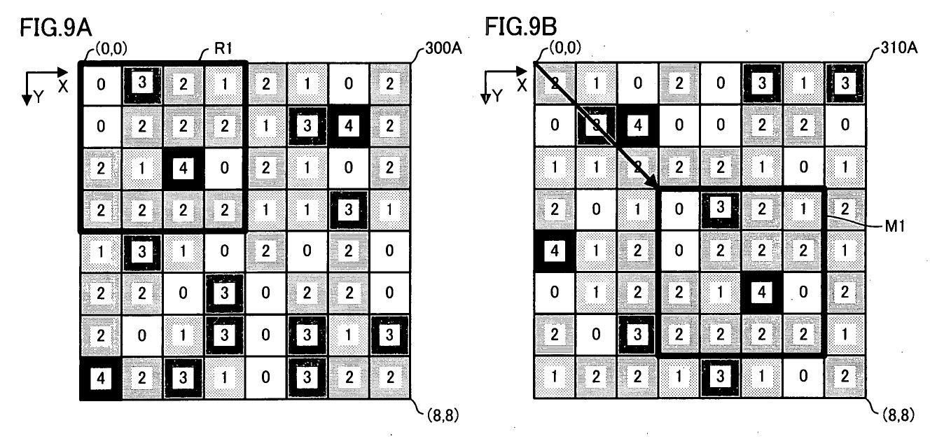

FIG. 9A illustrates region R1 set in comparison image 300A. FIG. 9A is similar to FIG. 8A, and therefore description thereof is not repeated.

FIG. 9B illustrates region R2 at the maximum similarity coordinate values. Region R2 arranged at the maximum similarity coordinate values may also be referred to as a maximum similarity region M1.

Therefore, the movement vector value can be calculated from the following equation (3).
Vi=(Vix, Viy)=(Mix−Rix, Miy−Riy) (3)

Mix indicates the x coordinate of the maximum similarity coordinate values. Miy indicates the y coordinate of the maximum similarity coordinate values. Rix indicates the x coordinate of region R1, and Riy indicates the y coordinate value of region R1.

Referring to FIG. 7 again, processing in step S122 is performed after the processing in step S120.

In step S122, the movement vector value calculated in step S120 is stored. More specifically, correlation value arithmetic unit 104 stores the movement vector value in storing unit 130. The correlation value arithmetic processing is completed through the foregoing processing.

Referring to FIG. 4, controller 125 includes data converter 105. Pointing device 100 further includes display controller 106 and display unit 110.

Correlation value arithmetic unit 104 reads the movement vector value stored in storing unit 130 and provides the movement vector value to data converter 105. Data converter 105 performs the conversion based on the movement vector value calculated by correlation value arithmetic unit 104 to provide an output value for causing display controller 106 to perform a predetermined operation.

Display controller 106 performs the control based on the output value provided from data converter 105 to move and display the pointer (cursor) on display unit 110.

As described above, the embodiment utilizes the comparison images which are based on the read fingerprint binary images successively read by fingerprint image reading unit 101, and are prepared by lowering the spatial resolutions and increasing of the density resolutions. Thereby, the arithmetic quantity required for calculating the movement vector can be significantly reduced as compared with the case of utilizing the read fingerprint binary image as it is.

Therefore, even when controller 125 uses an inexpensive arithmetic processor, the pointing device can function sufficiently. Consequently, it is possible to provide the inexpensive pointing device.

Since fingerprint image reading unit 101 can employ an inexpensive sensor obtaining the image information in the form of a binary image, the invention can provide the inexpensive pointing device.

The invention does not require a special sensor device which is required in the technique disclosed in Japanese Patent Laying-Open No. 2002-062983, and therefore can provide the inexpensive pointing device.

The invention does not require a finger plate or the like, which is required in the technique disclosed in Japanese Patent Laying-Open No. 2002-062983, and therefore can provide the pointing device achieving good operability.

According to the invention, the single device can achieve the personal collation function using the fingerprint and the function as the pointing device.

According to the embodiment, fingerprint collating unit 107, comparison image producing unit 102, correlation value arithmetic unit 104 and data converter 105 are included in single controller 125. However, the structure is not restricted to this, and various structures may be employed. For example, each of fingerprint collating unit 107, comparison image producing unit 102, correlation value arithmetic unit 104 and data converter 105 may be a processor independent of the others.

### Modification of the First Embodiment

In the first embodiment, pointing device 100 is provided with display unit 110. However, the structure is not restricted to this, and pointing device 100 may not be provided with display unit 110. In the invention, the pointing device may be an interface connectable to a personal computer.

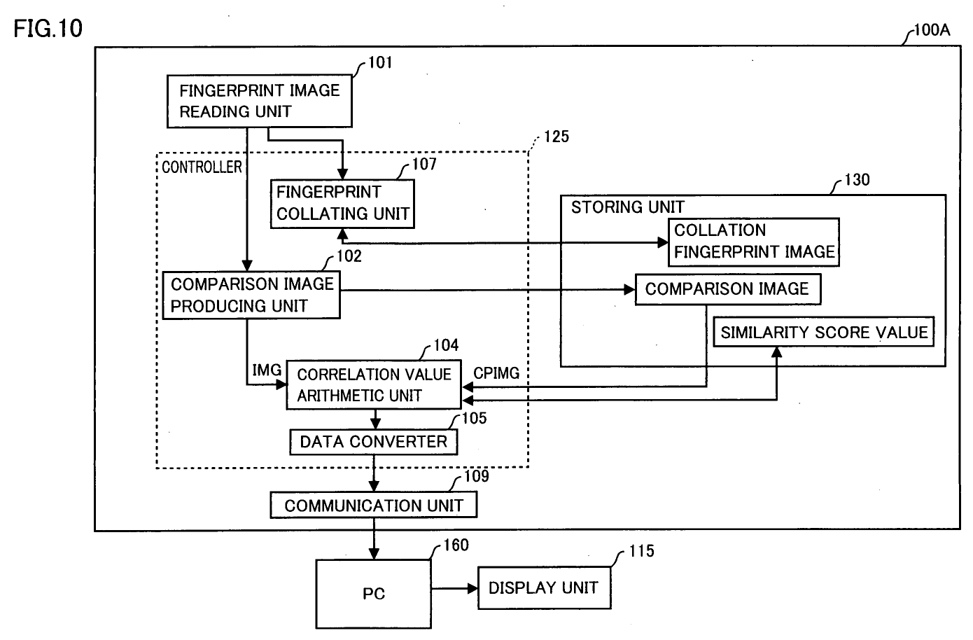

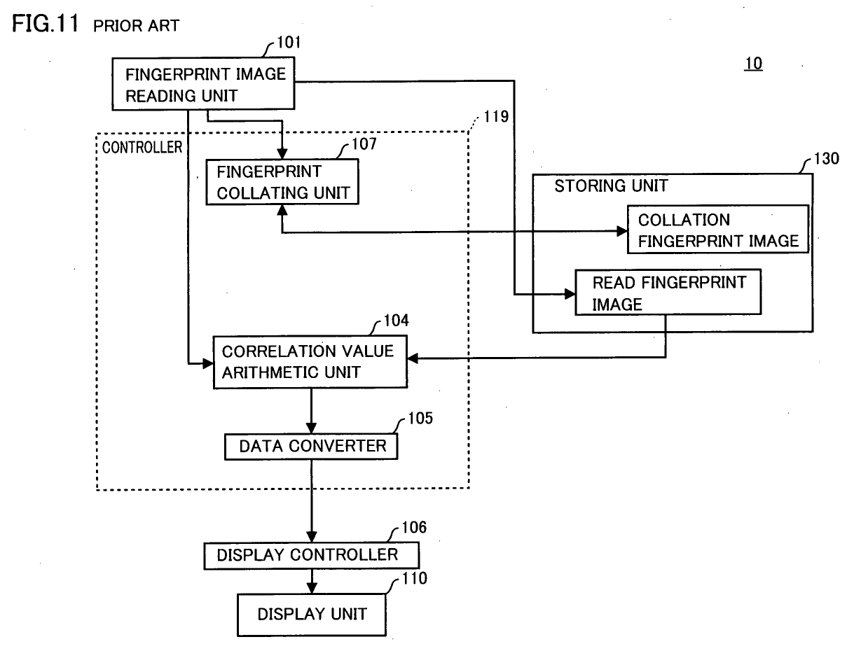

FIG. 10 is a block diagram illustrating a structure of a pointing device 100A connected to a personal computer (PC) 160. FIG. 10 also illustrates personal computer 160 and a display unit 115.

Referring to FIG. 10, pointing device 100A differs from pointing device 100 in FIG. 4 in that display controller 106 and display 110 are not employed. Pointing device 100A differs from pointing device 100 in that a communication unit 109 is employed.

Pointing device 100A is connected to personal computer 160 via communication unit 109. Personal computer 160 is connected to display unit 115. Display unit 115 displays the image based on the processing by personal computer 160. Display unit 115 has the substantially same structure as display 110 already described, and therefore description thereof is not repeated. Structures other than the above are substantially the same as those of pointing device 100, and therefore description thereof is not repeated.

Operations of pointing device 100A differ from those of pointing device 100 in the following operation.

Data converter 105 performs conversion based on the movement vector value calculated by correlation value arithmetic unit 104 to provide an output value for causing personal computer 160 to perform a predetermined operation. Data converter 105 provides the output value to communication unit 109.

Communication unit 109 may be USB (Universal Serial Bus) 1.1, USB 2.0 or another communication interface for serial transmission.

Communication unit 109 may be a Centronics interface, IEEE (Institute of Electrical and Electronic Engineers 1284) or another communication interface performing parallel transmission.

Also, communication unit 109 may be IEEE 1394 or another communication interface utilizing the SCSI standard.

Communication unit 109 provides the output value received from data converter 105 to personal computer 160.

Personal computer 160 performs the control based on the output value provided from communication unit 109 to move and display a pointer (cursor) on display unit 115.

As described above, pointing device 100A operates also as an interface connectable to personal computer 160. The structure of pointing device 100A described above can likewise achieve an effect similar to that of the first embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A pointing device comprising:
a sensor obtaining image information;
an image producing unit producing a comparison image at predetermined time intervals by lowering a spatial resolution of an image based on said image information obtained by said sensor and increasing a density resolution of said image based on said image information;
a storing unit storing a first comparison image among said plurality of comparison images produced by said image producing unit;
a correlation value arithmetic unit arithmetically obtaining a correlation value indicating a correlation between a predetermined region in a second comparison image produced by said image producing unit after said first comparison image among said plurality of comparison images and a predetermined region in said first comparison image; and
a data converter detecting an operation of a user from said correlation value, and converting said operation to an output value for supply to a computer.

2. The pointing device according to claim 1, further comprising:
a display unit displaying an image; and
a display controller moving a pointer on said display unit according to said output value.

3. The pointing device according to claim 1, wherein
said sensor obtains said image information in the form of a binary image, and
said image producing unit divides said binary image into a plurality of regions, calculates a conversion pixel value based on a plurality of pixel values provided by each of said plurality of regions, and produces said comparison image having said plurality of calculated conversion pixel values as the pixel values of the corresponding regions, respectively.

4. The pointing device according to claim 1, wherein
said sensor obtains a fingerprint or fingerprint image information derived from the fingerprint as the image information.

5. The pointing device according to claim 4, further comprising:
a fingerprint collating unit for collating said fingerprint image information with prestored fingerprint data.

6. The pointing device according to claim 1, wherein
an image information reading scheme of said sensor is a capacitance type, an optical type or a pressure-sensitive type.
